(19) United States
(12) Patent Application Publication
(10) Pub. No.: US 2025/0048074 A1
(43) Pub. Date: Feb. 6, 2025

(54) PRIVATE NETWORK AVAILABILITY AND ACCESSIBILITY REPORTING

(71) Applicant: Cisco Technology, Inc., San Jose, CA (US)

(72) Inventors: Srinath Gundavelli, San Jose, CA (US); Timothy Peter Stammers, Raleigh, NC (US); Vimal Srivastava, Bangalore (IN)

(21) Appl. No.: 18/363,069

(22) Filed: Aug. 1, 2023

(51) Int. Cl. H04W 8/02; H04W 12/00; H04W 24/10; H04W 60/00; H04W 64/00

(52) U.S. Cl. CPC H04W 8/02; H04W 12/009; H04W 24/10; H04W 60/00; H04W 64/00

(57) ABSTRACT

A Radio Access Network (RAN) node configures a User Equipment (UE) to provide measurement results for private wireless networks in the neighborhood of the UE. The RAN node registers the UE with a computer network and provides location information about the UE to an Application Function (AF) connected to the computer network. The RAN node obtains a partial identifier that specifies a range of private wireless networks selected by the AF, and sends a request to the UE for measurements associated with the range of private wireless networks.

### TECHNICAL FIELD

The present disclosure relates to wireless computer networking, specifically 5G private networks.

### BACKGROUND

Radio Access Network (RAN) equipment provides a wireless link between User Equipment (UE) and a 5G network. In the current Third Generation Partnership Project (3GPP), each UE may be configured to provide radio measurements of available and known RAN and/or Wireless Local Area Network (WLAN) nodes. For instance, a UE may be configured to measure neighboring access nodes to determine whether/when to attach to a different access node. Typically, a RAN node provides a list of Public Land Mobile Network (PLMN) identifiers for the attached UEs to measure and provide measurement reports. The RAN nodes primarily use the measurement reports for making cell selection/reselection decisions and Minimization of Drive Test (MDT).

### BRIEF DESCRIPTION OF THE DRAWINGS

FIG. 1 is simplified block diagram of a wireless network system configured to measure and report private wireless network available to a UE, according to an example embodiment.

FIG. 2 is a simplified block diagram that illustrates the messages exchanged in configuring the UE to report on private wireless networks, according to an example embodiment.

FIG. 3 is a message flow diagram illustrating an Application Function (AF) configuring a UE to measure available private wireless networks, according to an example embodiment.

FIG. 4 is a flowchart illustrating operations performed by a Radio Access Network (RAN) node to configure a UE to measure private wireless networks selected by an AF, according to an example embodiment.

FIG. 5 is a flowchart illustrating operations performed by a UE to measure private wireless networks selected by an AF and report the measurement results, according to an example embodiment.

FIG. 6 is a flowchart illustrating operations performed by an AF to select private wireless networks that may be available to a UE and to configure a UE to measure the private wireless networks, according to an example embodiment.

FIG. 7 is a block diagram of a computing device that may be configured to perform the techniques presented herein, according to an example embodiment.

### DETAILED DESCRIPTION

### Overview

A computer-implemented method is provided for a RAN node configuring a UE to provide measurement results for private wireless networks in the neighborhood of the UE. The method includes registering UE with a computer network and providing location information about the UE to an AF connected to the computer network. The method also includes obtaining a partial identifier that specifies a range of private wireless networks selected by the AF, and sending a request to the UE for measurements associated with the range of private wireless networks.

### Example Embodiments

The techniques presented herein enable a network operator to extend the functionality of UE measurement reports beyond the typical uses of cell selection/reselection, MDT, carrier aggregation, dual connectivity, handover, or UE positioning related features. Typically, the RAN equipment only configures UEs to measure PLMNs with an existing relationship, such as a home PLMN and PLMNs with a roaming agreement, for making cell selection/reselection within the home network or roaming/handoff decisions to roaming networks. The techniques presented herein enable the core network to learn about all of the networks (e.g., Standalone Non-Public Network (SNPN) or private wireless networks) that are available/accessible to a UE in a specific location. A network operator may monetize the knowledge of operational networks near a UE to enable the UE to use certain services available at that location.

In one example, the network operator may trigger various actions based on the knowledge of nearby private wireless networks. For instance, the network operator may trigger various modes of Access Traffic Steering. Switching, and Splitting (ATSSS) or convert a Single Access Packet Data Unit (SA-PDU) session to a Multi-Access Packet Data Unit (MA-PDU) session based on the availability of wireless private networks. Additionally, the network operator may dynamically create a relationship with the wireless private network on an as-needed basis. Furthermore, the network operator may adjust UE policy, Access Management (AM) policy, and/or Session Management (SM) policy based on the availability of SNPN networks (i.e., private wireless networks).

In another example, the network operator may hand over some of the sessions to an available private wireless network or enable the UE to access services of interest that are provided from local private wireless networks. Providing information about the availability of private wireless networks that are local to a UE may enable application services to determine additional use cases for the UE and the wireless private networks.

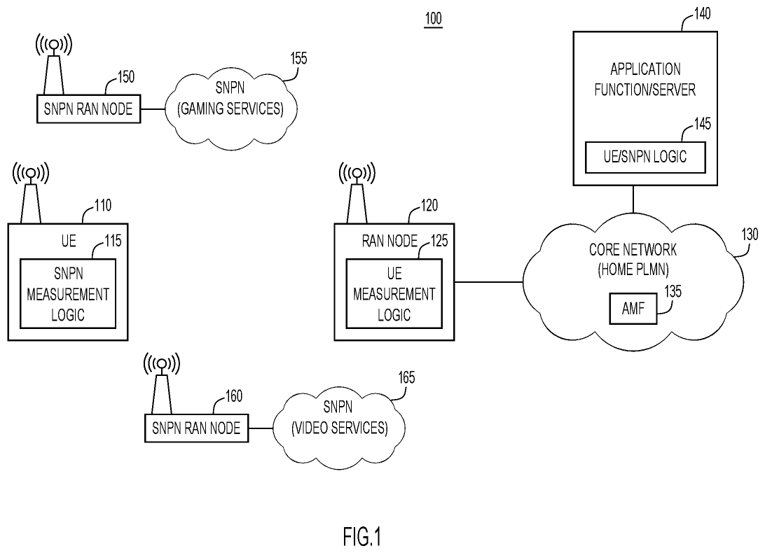

Referring now to FIG. 1, a block diagram shows a system 100 that is configured to provide information to a core network about private wireless networks that are local to a UE 110. The UE 110 includes SNPN logic 115 that enables the UE 110 to be configured to measure private wireless networks as described herein. The UE 110 is connected to a RAN node 120 (e.g., an evolved node B (eNB) or next generation node B (gNB)) that provides access to a core network 130. The RAN node 120 includes UE measurement logic 125 that enables the RAN node 120 to configure the UE 110 as described herein.

The core network 130 comprises network functions including an Access Management and Mobility Function (AMF) 135 that is configured to coordinate all of the sessions for UE that connect to the core network 130, such as the UE 110. In one example, the core network 130 may be a home PLMN for the UE 110. An application function (AF) 140 is connected to the core network 130. The AF 140 may be a server that is configured to provide a service for a UE (e.g., UE 110) that is attached to the core network 130. The AF 140 includes UE/SNPN logic 145 that enables the AF 140 to direct the RAN node 120 to configure the UE 110 to measure nearby SNPNs, as described herein.

As shown in FIG. 1, SNPN RAN node 150 and SNPN RAN node 160 are in the vicinity of the UE 110 and may be available for use by the UE 110. The SNPN RAN node 150 provides access to an SNPN 155 (e.g., a private wireless network for gaming services). The SNPN RAN node 160 provides access to an SNPN 165 (e.g., a private wireless network for video services).

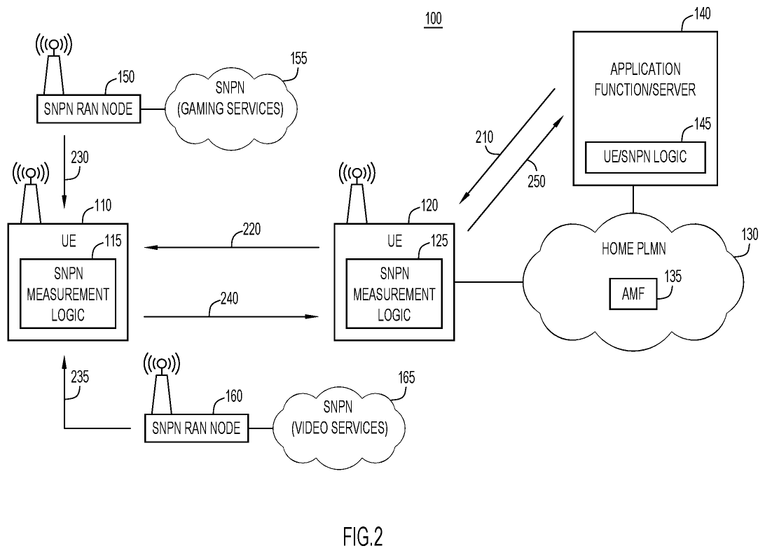

Referring now to FIG. 2, an example of the system 100 gathering information about neighboring private wireless networks is shown. After the core network 130 notifies the AF 140 that the UE 110 is connected to the RAN node 120, the AF 140 sends a message 210 to the RAN node 120 specifying a range of private wireless networks that may be operating in the neighborhood of the UE 110.

In one example, the core network 130 may provide the AF 140 with location information about the UE 110 to enable the AF 140 to select the range of private wireless networks. In another example, the message 210 may specify the range of private wireless networks by identifying one or more PLMN identifiers that include wildcard values. Once the RAN node 120 obtains the message 210 that specifies the range of private wireless networks, the RAN node 120 sends a measurement request 220 to the UE 110 that specifies the range of private wireless networks that the AF 140 has selected.

The UE 110 receives the broadcast messages 230 and 235 from the SNPN RAN nodes 150 and 160, respectively. The UE 110 may determine network information from the broadcast messages 230 and 235, such as a Network Identifier (NID) or a PLMN ID. If the network information from the broadcast messages 230 or 235 match the range of private wireless networks specified in the measurement request 220, then the UE sends measurement results 240 to the RAN node 120. The measurement results 240 may include radio measurements (e.g., Received Signal Strength Indicator (RSSI) measurements) from the broadcast message 230 and/or the broadcast message 235. Additionally, the measurement results 240 may include accessibility information that indicates whether the UE 110 has access to the SNPN 155 and/or the SNPN 165. The RAN node 120 forwards the measurement results in a message 250 to the AF 140.

In one example, the core network 130 may store the interest of the user of the UE 110 and instruct the UE 110 to access either the SNPN 155 or the SNPN 165 based on the interests of the user. For instance, a user may frequently use the UE 110 for gaming, and the core network 130 may configure the UE 110, through the RAN node 120, to access the SNPN 155 for gaming services.

In another example, the measurement results 240 may cause the core network 130 to trigger the UE 110 to route some of its network traffic to a locally available private wireless network (e.g., SNPN 165 or SNPN 155). For instance, the core network 130 may determine that the UE 110 should move one or more PDU sessions or provide ATSSS services to the UE 110.

In a further example, the SNPN 165 identified in the broadcast message 235 may not be included in the range of private wireless messages specified in the measurement request 220. In this case, the measurement results 240 may not include any indication that the UE 110 received the broadcast message 235 or that the SNPN 165 would be available to the UE 110.

In still another example, the AF 140 may process the measurement results 250 before requesting accessibility information from the UE 110. In other words, the AF 140 may separate the determination of which of the selected private wireless networks are detectable by the UE 110 from the determination of which of the detected private wireless networks are accessible to the UE 110.

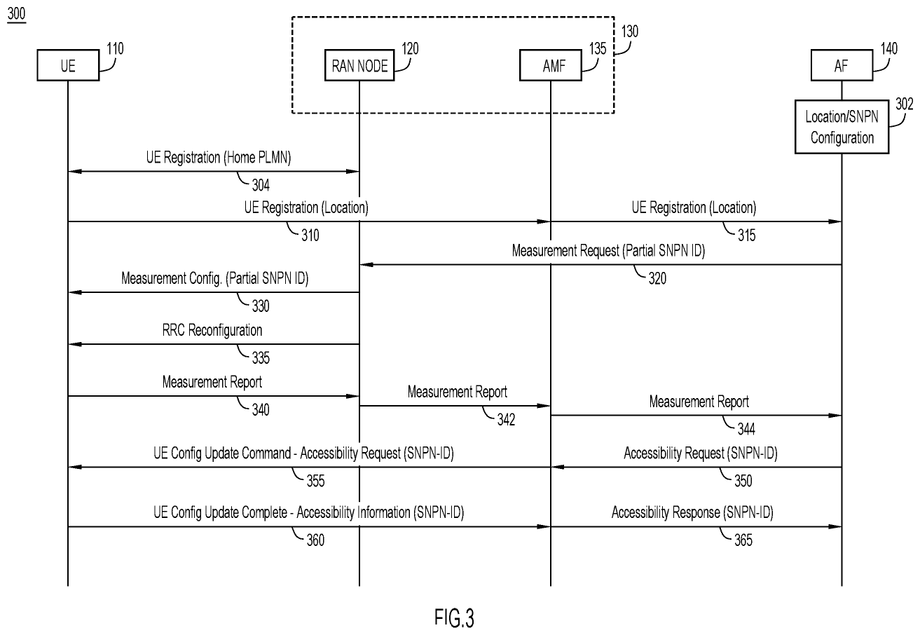

Referring now to FIG. 3, a message flow diagram illustrates an example flow 300 for determining the availability and accessibility of private wireless networks near a UE 110. Initially, the AF 140 is configured with data 302 that associates ranges of private wireless networks with various UE locations. In one example, the data 302 associates a UE location with a portion of a PLMN ID, such as a Mobile Country Code (MCC), with a wildcard value for the Mobile Network Code (MNC). In other words, the data 302 may associate UE locations in Australia with a PLMN ID of “505*” to capture all of the different MNCs available in the MCC “505” corresponding to Australia.

The UE 110 attaches to the core network 130 through a UE registration exchange 304. In one example, the UE registration exchange 304 may include the RAN node 120 broadcasting Master Information Block (MIB) and System Information Block 1 (SIB1) as the basic parameters for connecting to the RAN node 120. The UE registration exchange 304 may further include Random Access Channel (RACH) exchange to determine an available channel for communication and a Radio Resource Channel (RRC) setup exchange to provision the channel for communication.

Once the UE 110 is connected to the core network 130 through the RAN node 120, the UE 110 sends a UE registration 310 to the AMF 135 of the core network 130. In one example, the UE registration 310 includes location information for the UE 110, which the AMF 135 passes along to the AF 140 in a message 315. Based on the location information of the UE 110, the AF 140 determines a range of private wireless networks that may be available near the UE 110, and sends a measurement request 320 to the RAN node 120. In one example, the range of private wireless networks may be specified as one or more partial SNPN ID values. For instance, the measurement request 320 may identify a PLMN with a specific MCC and a plurality of specific MNC values, while excluding other MNC values. Alternatively, the range of private networks may be specified as a range of Network Identifier (NID) values without specifying a PLMN, or with wildcard values in the PLMN ID. In another example, the range of private wireless networks may be selected based on user information associated with the UE 110 (e.g., interest in specific services) or policy considerations (e.g., security of the networks).

The RAN node 120 sends a measurement configuration message 330 to the UE 110 identifying the range of private wireless networks about which the AF 140 is requesting information. In one example, the measurement configuration message 330 includes one or more partial SNPN identifiers, such as SNPN identifiers with wildcard values. The RAN node 120 also sends an RRC reconfiguration message 335 to trigger the UE 110 to measure the radio characteristics of the private wireless networks identified in the measurement configuration message 330.

Once the UE 110 has gathered radio measurements on all of the selected wireless private networks that are available near the UE 110, the UE 110 sends a measurement report 340 to the RAN node 120. The RAN node 120 forwards the measurement report in an N2 message 342 to the AMF 135. The AMF 135 forwards the measurement report to the AF 140 in a message 344.

The AF 140 may determine that the UE 110 would benefit from connecting to one or more of the locally available wireless private networks and trigger the AMF 135 and the core network 130 to reconfigure one or more sessions of the UE 110 to take advantage of services offered by a private wireless network. However, the UE 110 may not have access to all of the private wireless networks that were measured. The AF 140 triggers a query towards the UE 110 to determine which of the available private wireless networks (i.e., networks that are operating around the UE 110) are also accessible to the UE 110 (i.e., the UE 110 has credentials for the network).

The AF 140 triggers the query by sending an accessibility request 350 to the AMF 135 that includes an indication some or all of the available private wireless networks for which the UE 110 reported measurement results. The AMF 135 receives the accessibility request 350 and forwards it to the UE 110 as an accessibility request 355. In one example, the accessibility request 355 is formatted as a UE configuration update command that identifies the private wireless networks identified by the AF 140. The UE 110 responds to the accessibility request 355 by sending a response 360 to the AMF 135. The response 360 includes the accessibility information requested by the AF 140. In other words, the response 360 includes an indication of which of the available private wireless networks the UE 110 can access. In one example, the response 360 is formatted as a UE configuration complete response. The AMF 135 forwards the accessibility information to the AF 140 as an accessibility response 365.

Based on the availability and accessibility information about which private wireless networks are available and accessible to the UE 110, the AF 140 may trigger services and/or actions to support the UE 110. For instance, the AF 140 may trigger ATSSS, PDU session offloading to the private wireless network, enrolling the UE 110 in one or more services provided by the private wireless networks, and/or adjusting policies affecting the UE 110.

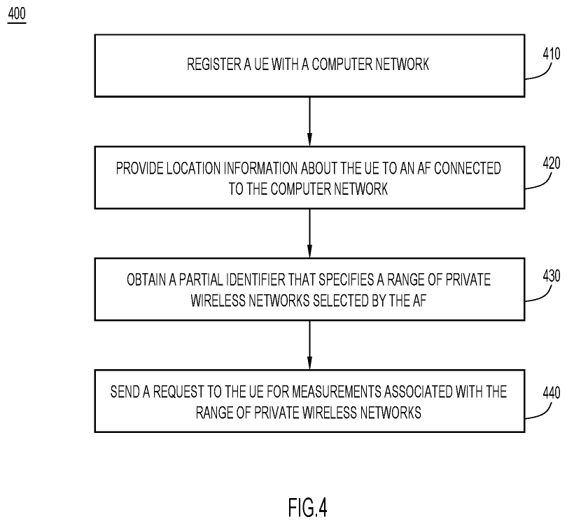

Referring now to FIG. 4, a flowchart illustrates an example, process 400 performed by a RAN node (e.g., RAN node 120) to report measurement results for a range of private wireless networks available to a UE attached to the RAN node. At 410, the RAN registers the UE with a computer network. In one example, the computer network may be a 5G home PLMN for the UE. The RAN node provides location information about the UE to an AF attached to the computer network at 420. In one example, the RAN node may provide the UE location information through one or more other network functions (e.g., AMF, SMF, etc.) in the computer network.

At 430, the RAN node obtains a partial identifier that specifies a range of private wireless networks selected by the AF. In one example, the partial identifier may include an SNPN ID with one or more wildcard entries. For instance, the partial identifier may identify the range of private wireless networks through a PLMN ID with a specific MCC and a wildcard value in the MNC portion of the PLMN ID. Alternatively, the partial identifier may identify the range of private wireless networks by specifying one or more NID values with wildcard values for the PLMN ID.

At 440, the RAN node sends a measurement request to the UE for measurements associated with the range of private wireless networks selected by the AF. In one example, the measurement request is at least part of an RRC reconfiguration request from the RAN node to the UE. In another example, the measurement request may include an Information Element (IE) that is extended to include the partial identifiers of the range of private wireless networks. For instance, the IE npn-IdentityList-r16 may be added to a LoggedMeasurementConfiguration-r16 IE that is sent to the UE.

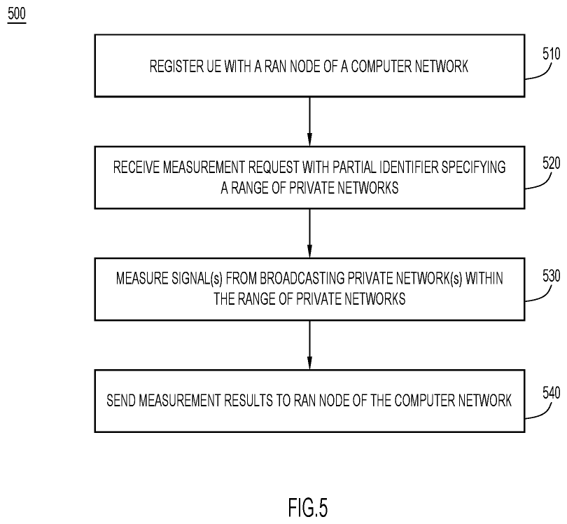

Referring now to FIG. 5, a flowchart illustrates an example, process 500 performed by a UE (e.g., UE 110) to provide radio measurements of a range of private wireless networks selected by an AF. At 510, the UE registers with a RAN node of a computer network when the UE attaches to the computer network. In one example, the UE may register with other network functions (e.g., an AMF) of the computer network. The UE receives a measurement request from the RAN node at 520. In one example, the measurement request may be formatted as a RRC reconfiguration request. The measurement request includes partial identifier that specifies a range of private wireless networks selected by the AF based on location information of the UE. the partial identifier may include an SNPN ID with one or more wildcard entries. For instance, the partial identifier may identify the range of private wireless networks through a PLMN ID with a specific MCC and a wildcard value in the MNC portion of the PLMN ID. Alternatively, the partial identifier may identify the range of private wireless networks by specifying one or more NID values with wildcard values for the PLMN ID.

At 530, the UE measure signals from broadcasting private wireless networks within the range of private wireless networks specified by the partial identifier. In one example, the UE may measure specific SNPN identifiers, RSSI information, or other radio information associated with the private wireless networks operating in the neighborhood of the UE. The UE sends the measurement results to the RAN node at 540. In one example, the UE may send a logMeasAvailableSNPN flag to the RAN node as an IE in a RRCReconfigurationComplete message. For instance, the ue-MeasAvailable-r16 IE may be extended to include the logMeasAvailableSNPN flag.

Based on the partial identifier, the UE records measurement results (e.g., neighboring cell reports) for any available private wireless network and provides the measurement results via the RAN node and the computer network to the AF that selected the range of private wireless networks. In one example, existing reporting IEs may provide a mechanism to provide the measurement results of the private wireless networks to the AF.

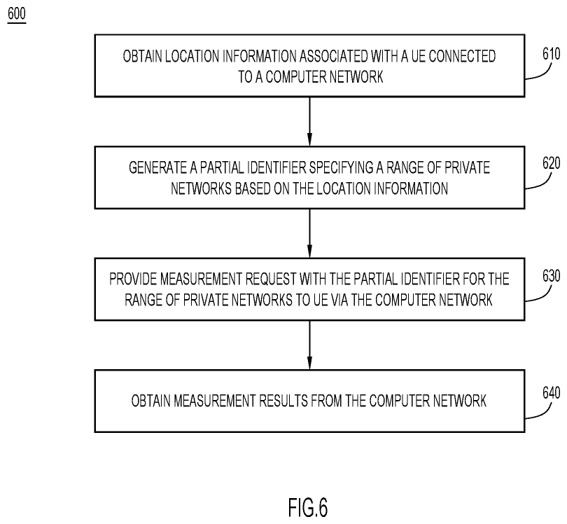

Referring now to FIG. 6, a flowchart illustrates an example process 600 performed by an AF (e.g., AF 140) to support a UE with services provided by nearby private wireless networks. At 610, the AF obtains location information associated with a UE connected to a computer network. Based at least in part on the location information, the AF generates a partial identifier specifying a range of private wireless networks at 620. In one example, the partial identifier may include an SNPN ID with one or more wildcard entries. For instance, the partial identifier may identify the range of private wireless networks through a PLMN ID with a specific MCC and a wildcard value in the MNC portion of the PLMN ID. In another example, the partial identifier may identify the range of private wireless networks by specifying one or more NID values with wildcard values for the PLMN ID. In another example, the AF may select the range of private wireless networks based on user preferences, services available at the private wireless networks, and/or network policies.

At 630, the AF provides a measurement request to the UE via the computer network. The measurement request includes the partial identifier specifying the range of private wireless networks. In one example, the measurement request may request the availability of the range of private wireless networks and the accessibility of the UE to any available private wireless networks. Alternatively, the AF may request the availability of the range of private wireless networks separately from any request for accessibility information from the UE.

At 640, the AF obtains measurement results from the computer network. The measurement results indicate which private wireless networks in the range of private wireless networks is available to the UE. In one example, the AF may request accessibility information from the UE to determine which of the available private wireless networks are accessible to the UE. In another example, the AF may prompt the UE to connect to one or more of the private wireless networks and take advantage of the services provided by the private wireless networks. Additionally, the AF may prompt the computer network (e.g., an AMF, SMF, gNB, etc.) to adjust the UE sessions and enable the UE to benefit from the services (e.g., gaming services, video services, etc.) provided by the private wireless networks.

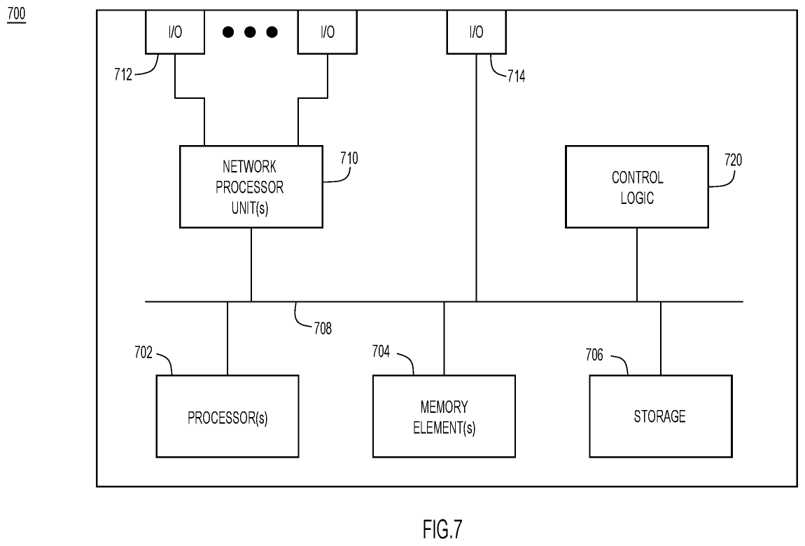

Referring to FIG. 7, FIG. 7 illustrates a hardware block diagram of a computing device 700 that may perform functions associated with operations discussed herein in connection with the techniques depicted in FIGS. 1-6. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm·wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein provide for providing a computer network, such as a 5G core network, insight into all available private wireless networks that may be available to a UE. The core network may then allow the user of the UE to use the services offered by the private wireless networks.

In some aspects, the techniques described herein relate to a method including: registering a User Equipment (UE) with a computer network; providing location information about the UE to an Application Function (AF) connected to the computer network; obtaining a partial identifier that specifies a range of private wireless networks selected by the AF; and sending a request to the UE for measurements associated with the range of private wireless networks.

In some aspects, the techniques described herein relate to a method, further including: receiving measurement results from the UE, the measurement results identifying one or more private wireless networks from the range of private wireless networks selected by the AF; and providing the measurement results to the AF.

In some aspects, the techniques described herein relate to a method, wherein the request for the measurements associated with the range of private wireless networks includes a request for accessibility information.

In some aspects, the techniques described herein relate to a method, wherein the measurement results include accessibility information associated with the one or more private wireless networks.

In some aspects, the techniques described herein relate to a method, wherein the partial identifier includes a Standalone Non-Public Network (SNPN) identifier with at least one wildcard value.

In some aspects, the techniques described herein relate to a method, wherein the AF selects the range of private wireless networks based on one or more of a service type of the private wireless networks, the location information about the UE, or policy preferences.

In some aspects, the techniques described herein relate to a method, wherein the request for measurements associated with the range of private wireless networks is formatted as a Radio Resource Control (RRC) reconfiguration message.

In some aspects, the techniques described herein relate to an apparatus including: a network interface configured to communicate with computing devices in one or more computer networks; a wireless network interface configured to communicate with a plurality of User Equipment (UE); and a processor coupled to the network interface and the wireless network interface, the processor configured to: register a UE among the plurality of UE for access to the one or more computer networks; cause the network interface to provide location information about the UE to an Application Function (AF) connected to the one or more computer networks; obtaining a partial identifier via the network interface, the partial identifier specifying a range of private wireless networks selected by the AF; and cause the wireless network interface to send a request to the UE for measurements associated with the range of private wireless networks.

In some aspects, the techniques described herein relate to an apparatus, wherein the processor is further configured to: receive measurement results from the UE via the wireless network interface, the measurement results identifying one or more private wireless networks from the range of private wireless networks selected by the AF; and cause the network interface to provide the measurement results to the AF.

In some aspects, the techniques described herein relate to an apparatus, wherein the processor is configured to include a request for accessibility information in the request for the measurements associated with the range of private wireless networks.

In some aspects, the techniques described herein relate to an apparatus, wherein the measurement results include accessibility information associated with the one or more private wireless networks.

In some aspects, the techniques described herein relate to an apparatus, wherein the partial identifier includes a Standalone Non-Public Network (SNPN) identifier with at least one wildcard value.

In some aspects, the techniques described herein relate to an apparatus, wherein the processor is configured to format the request for measurements associated with the range of private networks as a Radio Resource Control (RRC) reconfiguration message.

In some aspects, the techniques described herein relate to one or more non-transitory computer readable storage media encoded with software including computer executable instructions that, when the software is executed on a computing device, is operable to cause a processor of the computing device to: register a User Equipment (UE) with a computer network; provide location information about the UE to an Application Function (AF) connected to the computer network; obtain a partial identifier that specifies a range of private wireless networks selected by the AF; and send a request to the UE for measurements associated with the range of private wireless networks.

In some aspects, the techniques described herein relate to one or more non-transitory computer readable storage media, wherein the software is further operable to cause the processor to: receive measurement results from the UE, the measurement results identifying one or more private wireless networks from the range of private wireless networks selected by the AF; and provide the measurement results to the AF.

In some aspects, the techniques described herein relate to one or more non-transitory computer readable storage media, wherein the software is further operable to cause the processor to include a request for accessibility information with the request for the measurements associated with the range of private wireless networks.

In some aspects, the techniques described herein relate to one or more non-transitory computer readable storage media, wherein the measurement results include accessibility information associated with the one or more private wireless networks.

In some aspects, the techniques described herein relate to one or more non-transitory computer readable storage media, wherein the partial identifier includes a Standalone Non-Public Network (SNPN) identifier with at least one wildcard value.

In some aspects, the techniques described herein relate to one or more non-transitory computer readable storage media, wherein the AF selects the range of private wireless networks based on one or more of a service type of the private wireless networks, the location information about the UE, or policy preferences.

In some aspects, the techniques described herein relate to one or more non-transitory computer readable storage media, wherein the software is further operable to cause the processor to format the request for measurements associated with the range of private wireless networks as a Radio Resource Control (RRC) reconfiguration message.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
registering a User Equipment (UE) with a computer network;
providing location information about the UE to an Application Function (AF) connected to the computer network;
obtaining a partial identifier that specifies a range of private wireless networks selected by the AF; and
sending a request to the UE for measurements associated with the range of private wireless networks.

2. The method of claim 1, further comprising:
receiving measurement results from the UE, the measurement results identifying one or more private wireless networks from the range of private wireless networks selected by the AF; and
providing the measurement results to the AF.

3. The method of claim 2, wherein the request for the measurements associated with the range of private wireless networks includes a request for accessibility information.

4. The method of claim 3, wherein the measurement results include accessibility information associated with the one or more private wireless networks.

5. The method of claim 1, wherein the partial identifier comprises a Standalone Non-Public Network (SNPN) identifier with at least one wildcard value.

6. The method of claim 1, wherein the AF selects the range of private wireless networks based on one or more of a service type of the private wireless networks, the location information about the UE, or policy preferences.

7. The method of claim 1, wherein the request for measurements associated with the range of private wireless networks is formatted as a Radio Resource Control (RRC) reconfiguration message.

8. An apparatus comprising:
a network interface configured to communicate with computing devices in one or more computer networks;
a wireless network interface configured to communicate with a plurality of User Equipment (UE); and
a processor coupled to the network interface and the wireless network interface, the processor configured to:
register a UE among the plurality of UE for access to the one or more computer networks;
cause the network interface to provide location information about the UE to an Application Function (AF) connected to the one or more computer networks;
obtaining a partial identifier via the network interface, the partial identifier specifying a range of private wireless networks selected by the AF; and
cause the wireless network interface to send a request to the UE for measurements associated with the range of private wireless networks.

9. The apparatus of claim 8, wherein the processor is further configured to:
receive measurement results from the UE via the wireless network interface, the measurement results identifying one or more private wireless networks from the range of private wireless networks selected by the AF; and
cause the network interface to provide the measurement results to the AF.

10. The apparatus of claim 9, wherein the processor is configured to include a request for accessibility information in the request for the measurements associated with the range of private wireless networks.

11. The apparatus of claim 10, wherein the measurement results include accessibility information associated with the one or more private wireless networks.

12. The apparatus of claim 8, wherein the partial identifier comprises a Standalone Non-Public Network (SNPN) identifier with at least one wildcard value.

13. The apparatus of claim 8, wherein the processor is configured to format the request for measurements associated with the range of private networks as a Radio Resource Control (RRC) reconfiguration message.

14. One or more non-transitory computer readable storage media encoded with software comprising computer executable instructions that, when the software is executed on a computing device, is operable to cause a processor of the computing device to:
register a User Equipment (UE) with a computer network;
provide location information about the UE to an Application Function (AF) connected to the computer network;
obtain a partial identifier that specifies a range of private wireless networks selected by the AF; and
send a request to the UE for measurements associated with the range of private wireless networks.

15. The one or more non-transitory computer readable storage media of claim 14, wherein the software is further operable to cause the processor to:
receive measurement results from the UE, the measurement results identifying one or more private wireless networks from the range of private wireless networks selected by the AF; and
provide the measurement results to the AF.

16. The one or more non-transitory computer readable storage media of claim 15, wherein the software is further operable to cause the processor to include a request for accessibility information with the request for the measurements associated with the range of private wireless networks.

17. The one or more non-transitory computer readable storage media of claim 16, wherein the measurement results include accessibility information associated with the one or more private wireless networks.

18. The one or more non-transitory computer readable storage media of claim 14, wherein the partial identifier comprises a Standalone Non-Public Network (SNPN) identifier with at least one wildcard value.

19. The one or more non-transitory computer readable storage media of claim 14, wherein the AF selects the range of private wireless networks based on one or more of a service type of the private wireless networks, the location information about the UE, or policy preferences.

20. The one or more non-transitory computer readable storage media of claim 16, wherein the software is further operable to cause the processor to format the request for measurements associated with the range of private wireless networks as a Radio Resource Control (RRC) reconfiguration message.
